(19) United States
(12) Patent Application Publication
(10) Pub. No.: US 2024/0319104 A1
(43) Pub. Date: Sep. 26, 2024

(54) OPTICAL INSPECTION APPARATUS, OPTICAL INSPECTION METHOD, AND NON-TRANSITORY STORAGE MEDIUM STORING OPTICAL INSPECTION PROGRAM

(71) Applicant: KABUSHIKI KAISHA TOSHIBA, Tokyo (JP)

(72) Inventors: Hiroshi OHNO, Tokyo (JP); Kenta TAKANASHI, Kawasaki Kanagawa (JP); Hiroya KANO, Kawasaki Kanagawa (JP); Hideaki OKANO, Yokohama Kanagawa (JP)

(73) Assignee: KABUSHIKI KAISHA TOSHIBA, Tokyo (JP)

(21) Appl. No.: 18/514,512

(22) Filed: Nov. 20, 2023

(30) Foreign Application Priority Data
Mar. 22, 2023 (JP) 2023-045778

(51) Int. Cl. G01N 21/88

(52) U.S. Cl. CPC G01N 21/8806; G01N 2021/8845

(57) ABSTRACT

According to the embodiment, an optical inspection apparatus includes a single-pixel light receiving element, an image formation optical element, and a light beam selection portion. The image formation optical element is disposed at a position where the single-pixel light receiving element configured to receive image points corresponding to at least two different object points of an object. The light beam selection portion is provided between the image formation optical element and the single-pixel light receiving element and is configured to selectively shield at least one wavelength included in lights from the object points.

### CROSS-REFERENCE TO RELATED APPLICATIONS

This application is based upon and claims the benefit of priority from Japanese Patent Application No. 2023-045778, filed Mar. 22, 2023, the entire contents of all of which are incorporated herein by reference.

### FIELD

Embodiments described herein relate generally to an optical inspection apparatus, an optical inspection method, and a non-transitory storage medium storing an optical inspection program.

### BACKGROUND

Non-contact optical inspection of objects is important in various industries. As a technique of such optical inspection, there is single pixel imaging in which an object is irradiated with a large number of pattern lights one after another, time-series signals acquired by one highly sensitive light receiving element (single pixel) are acquired, and the pattern lights are correlated with the signals, thereby performing imaging. Since one light receiving element is used in the single pixel imaging, a large, highly sensitive light receiving element can be used. This provides an advantage that even weak light can be detected. Such single pixel imaging can image a transmittance distribution or a reflectance distribution of an object.

### BRIEF DESCRIPTION OF DRAWINGS

FIG. 1 is a schematic cross-sectional view illustrating an optical inspection apparatus according to a first embodiment.

FIG. 2 is a processing flowchart in a case where optical inspection processing is performed using a processing unit of the optical inspection apparatus illustrated in FIG. 1.

FIG. 3 is a schematic cross-sectional view illustrating an optical inspection apparatus according to Modification 1 of the first embodiment.

FIG. 4 is a processing flowchart in a case where an image of an object is acquired using the optical inspection apparatus illustrated in FIG. 3.

FIG. 5 is a schematic cross-sectional view illustrating an optical inspection apparatus according to Modification 2 of the first embodiment.

FIG. 6 is a schematic cross-sectional view illustrating an optical inspection apparatus according to a second embodiment.

FIG. 7 is a schematic cross-sectional view illustrating an optical inspection apparatus according to a modification of the second embodiment.

FIG. 8 is a schematic front view illustrating a second light beam selection portion (color wheel) provided between a light source and a DMD in FIG. 7.

FIG. 9 is a schematic cross-sectional view illustrating an optical inspection apparatus according to a third embodiment.

FIG. 10 is a schematic cross-sectional view illustrating an optical inspection apparatus according to a fourth embodiment.

FIG. 11 is a schematic cross-sectional view illustrating an optical inspection apparatus according to a fifth embodiment.

FIG. 12 is a schematic cross-sectional view illustrating an optical inspection apparatus according to a sixth embodiment.

### DETAILED DESCRIPTION

It is an object of an embodiment to provide an optical inspection apparatus using a single pixel, an optical inspection method, and a non-transitory storage medium storing an optical inspection program, which are configure to obtain information on a directional distribution of light, or configured to calculate information on an object.

According to the embodiment, an optical inspection apparatus includes a single-pixel light receiving element, an image formation optical element, and a light beam selection portion. The image formation optical element is disposed at a position where the single-pixel light receiving element configured to receive image points corresponding to at least two different object points of an object. The light beam selection portion is provided between the image formation optical element and the single-pixel light receiving element and is configured to selectively shield at least one wavelength included in lights from the object points.

Each embodiment will be described later with reference to the drawings. The drawings are schematic or conceptual, and a relationship between a thickness and a width of each portion, a size ratio between portions, and the like are not necessarily the same as actual ones. In addition, even the same portion may be represented in the drawings differently in dimensions and ratios. In the specification and the drawings of the present application, the same reference numerals are given to the same elements as those described above with regard to the previously referenced drawings, and detailed descriptions thereof are omitted as appropriate.

### First Embodiment

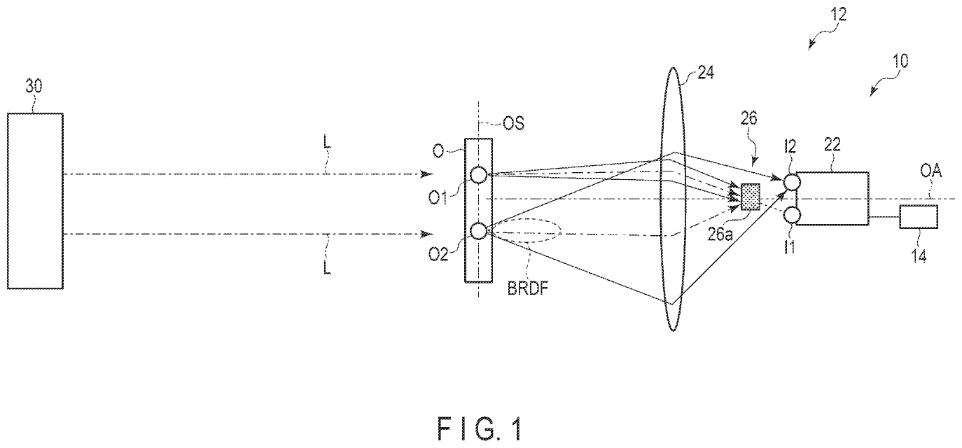

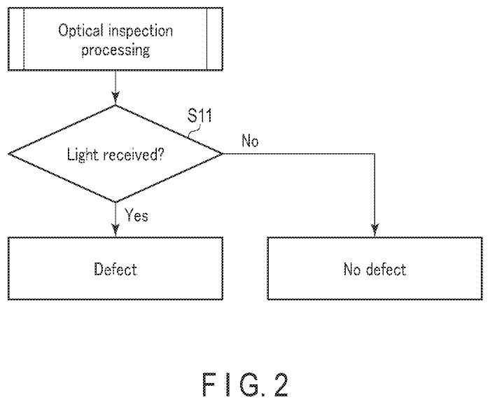

Hereinafter, an optical inspection apparatus 10 according to a first embodiment will be described with reference to FIGS. 1 and 2.

In the present specification, light is a type of electromagnetic wave, and includes gamma rays, X-rays, ultraviolet rays, visible light, infrared rays, and radio waves. In the present embodiment, light is visible light which has a wavelength, for example, in a region of 400 nm to 750 nm.

FIG. 1 shows a schematic cross-sectional view illustrating an optical inspection apparatus 10 according to the present embodiment.

The optical inspection apparatus 10 according to the present embodiment includes an imaging unit 12 and a processing unit 14.

The imaging unit 12 includes a single-pixel light receiving element 22, an image formation optical element 24, and a light beam selection portion 26.

The single-pixel light receiving element 22 is, for example, a photodiode (PD). The material for the PD may be, for example, Si, InGaAs, Ge, or Si/InGaAs. The wavelength range in which light can be received may be, for example, 200 nm to 2600 nm. In the present embodiment, it is assumed that the single-pixel light receiving element 22 can receive at least white light which is visible light. However, the single-pixel light receiving element 22 is not limited to this, and may receive light in any wavelength range as long as it has one light receiving surface (one pixel). Furthermore, the single-pixel light receiving element 22 may be, for example, a high-sensitivity element such as a photomultiplier tube.

The processing unit 14 controls the single-pixel light receiving element 22 of the imaging unit 12, and performs processing of acquiring information on a directional distribution of light which will be described later, and/or calculating information on the object.

The processing unit 14 includes, for example, a computer and the like, and includes one or more processor (processing circuit) and a storage medium. The processor includes any of a central processing unit (CPU), an application specific integrated circuit (ASIC), a microcomputer, a field programmable gate array (FPGA), a digital signal processor (DSP), and the like. The storage medium may include a non-transitory auxiliary storage device in addition to a main storage device such as a memory. Examples of the storage medium include non-volatile memories capable of writing and reading at any time, such as a hard disk drive (HDD), a solid state drive (SSD), a magnetic disk, an optical disk (CD-ROM, CD-R, DVD, etc.), a magneto-optical disk (MO or the like), and a semiconductor memory.

In the processing unit 14, only one processor and only one storage medium may be provided, or a plurality of processors and a plurality of storage media may be provided. In the processing unit 14, the processor performs processing by executing a program or the like stored in a storage medium or the like. Furthermore, the program executed by the processor of the processing unit 14 may be stored in a computer (server) connected to the processing unit 14 via a network such as the Internet, a server in a cloud environment, or the like. In this case, the processor downloads the program via the network. Here, it is assumed that an optical inspection program is mounted on a non-transitory storage medium of the processing unit 14.

Image acquisition from the single-pixel light receiving element 22 and various types of calculation processing based on the image acquired from the single-pixel light receiving element 22, in the processing unit 14, are executed by the processor or the like, and the storage medium functions as a data storage unit.

Furthermore, at least a part of the processing by the processing unit 14 may be executed by a cloud server configured in the cloud environment. An infrastructure of the cloud environment is includes a virtual processor such as a virtual CPU and a cloud memory. In one example, image acquisition from the single-pixel light receiving element 22 and various types of calculation processing based on the image acquired from the single-pixel light receiving element 22 are executed by the virtual processor, and the cloud memory functions as a data storage unit.

Note that, in the present embodiment, the processing unit 14 controls the single-pixel light receiving element 22 and performs various arithmetic computations on image data obtained from the single-pixel light receiving element 22.

The processing unit 14 is configured to distinguish, for example, whether the light of the first wavelength spectrum or the light of the second wavelength spectrum has been imaged, from light reception signal intensities (pixel values) of a plurality of color channels in the pixel acquired by the single-pixel light receiving element 22. Furthermore, the processing unit 14 can identify whether the light of the first wavelength spectrum and the light of the second wavelength spectrum have been simultaneously imaged or only one of them has been imaged, based on the pixel value of each color channel. That is, the processing unit 14 can identify whether only the first wavelength spectrum has been imaged, only the second wavelength spectrum has been imaged, or both of them have been imaged at the same time, or neither of them has been imaged, in each pixel.

As illumination light of the optical inspection apparatus 10 according to the present embodiment, a special light source may be prepared, but is not always necessary. For example, it may be ambient light in an office or the like, or natural light such as sunlight. Alternatively, the illumination light may be light from a light source, and any light source may be used as long as it emits light, for example, a laser light source, a laser diode (LD) light source, a light emitting diode (LED) light source, a filament light source, a halogen lamp, or a xenon lamp. In the present embodiment, the illumination light is ambient light from a ceiling lamp. The distance between an object O and a ceiling is sufficiently long and separated by several meters, and beam-shaped white light having high parallelism reaches the object O. It is assumed that a wavelength spectrum of the white light has a significant intensity in a wavelength range from 450 nm to 750 nm.

The image formation optical element 24 is, for example, an imaging lens. In FIG. 1, the imaging lens 24 is schematically represented by one lens, but may be a set lens including a plurality of lenses. Alternatively, the image formation optical element 24 may be a concave mirror, a convex mirror, or a combination thereof. Alternatively, the image formation optical element 24 may be formed of a refractive index distribution medium such as a GRIN lens. Alternatively, the image formation optical element 24 may be a diffractive lens. That is, the image formation optical element 24 may be any optical element as long as the optical element has a function of collecting light beams emitted from a point of the object O, that is, object points O1 and O2 at conjugate image points I1 and I2, respectively. The phenomenon that the light beams emitted from the object points O1 and O2, for example, on a surface of the object O are collected (condensed) at the image points I1 and I2, respectively, by the image formation optical element 24 is referred to as imaging. Alternatively, the image formation means that the object points O1 and O2 are transferred to the image points (conjugate points of the object points) I1 and I2, respectively. In addition, a collection surface of conjugate points to which light beams emitted from sufficiently far object points are transferred by the image formation optical element 24 is referred to as focal plane of the image formation optical element 24. In addition, a line perpendicular to the focal plane and passing through the center of the image formation optical element 24 is defined as optical axis OA. At this time, the conjugate image points I1 and I2 of the object points O1 and O2 transferred by the light beams are referred to as focal points. However, in this case, the image points I1 and I2 coincide with each other.

The imaging unit 12 transfers the light from the object point O1 to the image point I1 along the optical axis OA, and transfers the light from the object point O2 to the image point 12 along the optical axis OA. However, the optical axis OA may be folded back by a mirror or branched by a beam splitter or the like. That is, the optical axis OA may be folded back in a plurality of times or may be a plurality of pieces.

The light beam selection portion 26 is disposed in a region occupied by the light beams passing through the image formation optical element 24 from the object points O1 and O2. That is, light beam selection portion 26 is disposed on the optical axis OA of the imaging unit 12. However, the light beam selection portion 26 and the optical axis OA do not necessarily intersect with each other. That is, “the light beam selection portion 26 is disposed on the optical axis OA” means that the light beam selection portion 26 is disposed in a region occupied by the light beams passing through the image formation optical element 24 toward the imaging unit 12. The light beam selection portion 26 is desirably disposed at or near the focal plane of the image formation optical element 24, but is not limited thereto. For example, the light beam selection portion 26 is disposed in parallel to the focal plane in the vicinity of the focal plane of the image formation optical element 24. Then, the light beam selection portion 26 selectively shields at least one wavelength of the lights from the object points O1 and O2. In the same sense as this, it may be described that the light beam selection portion 26 selectively shields the light with respect to the object points O1 and O2.

The light beam selection portion 26 includes, for example, a first selection region 26a. However, the number of selected regions is not limited to this, and may be any number as long as the light beam selection portion 26 has at least one selection region. The first selection region 26a is a shielding region that shields light. The light does not pass through the shielding region 26a. That is, the shielding region 26a does not allow the light from the object point O1 to reach the single-pixel light receiving element 22. In other words, the shielding region 26a shields light by reflecting or absorbing the light. However, the light beam selection portion 26 is not limited to this, and may be a wavelength selection region. Different wavelength selection regions allow lights of a plurality of different wavelength spectra, in the illumination light including the lights of the different wavelength spectra, to pass therethrough. Here, “allowing light to pass therethrough” means directing the light toward the single-pixel light receiving element 22. In the same sense as this, it may be described that the wavelength selection region allows light to selectively pass therethrough, or the wavelength selection region selectively transmits light. That is, the wavelength selection region allows light of a wavelength spectrum in which light of at least one wavelength among the wavelength spectra of the illumination light is shielded to pass therethrough. This will be described in Modification 2 which will be given later. For example, the wavelength selection region includes the shielding region 26a, and the shielding region 26a shields all the lights of the wavelength spectra of the illumination light. On the other hand, it may allow light of a wavelength spectrum that is not included in the wavelength spectra of the illumination light to pass therethrough. As a result, the illumination light cannot pass through the shielding region 26a of the wavelength selection region, resulting in an effect that information on the directional distribution of light (BRDF: bidirectional reflectance distribution function) at each of the object points O1 and O2 can be acquired. The light beam selection portion 26 is not limited to the wavelength selection region, and may be a polarized light selection region formed of a polarizing plate. In the present embodiment, the illumination is non-polarized ambient light, and thus the polarized light of the illumination is obtained by superimposing S-polarized light and P-polarized light. The polarized light selection region allows light of a polarization different from the polarization itself of the illumination light to pass therethrough. That is, the polarized light selection region allows light of a predetermined polarization among lights of non-polarization included in the illumination light. For example, it is assumed that the polarized light selection region has the shielding region 26a. In a case where the illumination light has linearly polarized light instead of non-polarized light, and the polarized light is S-polarized light, the shielding region 26a allows only polarized light (P-polarized light) orthogonal thereto to pass therethrough. On the other hand, the same S-polarized light as that of the illumination light is shielded. As a result, the illumination light cannot pass through the shielding region 26a of the polarized light selection region, resulting in an effect that information on the directional distribution of light (BRDF) at each of the object points O1 and O2 can be acquired.

A first selection portion 26a of the light beam selection portion 26 is formed in a disk shape having a small diameter, for example. For example, the first selection portion 26a of the light beam selection portion 26 is formed to have such a size that it shields, at the focal plane, light converging at the focal point but allows light passing away from the focal point at the focal plane to reach the single-pixel light receiving element 22.

An operation of the optical inspection apparatus 10 according to the present embodiment will be described.

The object O may be transparent or opaque. In the present embodiment, the object O is a transparent body of a medium having a small thickness and a uniform refractive index. However, in the present embodiment, the object O is not limited to this. In a case where the object O is opaque, the illumination is emitted from an imaging side to observe reflected light. At this time, the illumination light may be folded back by a beam splitter (half mirror) or the like.

In a case where there is a minute defect in the object O, that is, in a case where there is a non-uniform minute region locally, the light is scattered upon incident of the minute defect with the illumination light, and the directional distribution of light (BRDF) is generally widened. On the other hand, in the case of a medium having a uniform refractive index without a minute defect in the object O, the light is not scattered and passes while maintaining the same directional distribution of light (BRDF) as that at the time of incidence. Hereinafter, a medium having a uniform refractive index is referred to as a uniform medium. However, even in a case where the object O is a uniform medium, light is reflected at an interface of the object O. This reflection is Fresnel reflection.

It is assumed that the first object point O1 is on the uniform medium, and that a minute defect exists at the second object point O2. Then, the directional distribution of light is not widened, and thus the light from the first object point O1 passes through the image formation optical element 24 and is then shielded by the first selection region 26a. On the other hand, the light from the second object point O2 is scattered, and the directional distribution of light is widened, and thus a part of the light from the second object point O2 that reaches the single-pixel light receiving element 22 without being shielded by the first selection region 26a after passing through the image formation optical element 24 is generated. That is, the light from the first object point O1 is not received by the single-pixel light receiving element 22, and the light from the second object point O2 is received by the single-pixel light receiving element 22.

Conversely, in a case where there is a minute defect at the first object point O1, the directional distribution of light is widened, and the light is received by the single-pixel light receiving element 22. In addition, in a case where there is no minute defect at the second object point O2 and the second object point is on a uniform medium, the direction of light is not widened and the light is not received by the single-pixel light receiving element 22. As a result, in a case where there is a minute defect in at least one of the two object points O1 and O2, the light is received by the single-pixel light receiving element 22. On the other hand, in a case where there is no minute defect at either of the two object points O1 and O2 and the object points are on a uniform medium, the light is not received by the single-pixel light receiving element 22.

That is, the processor of the processing unit 14 can detect a minute defect at the two object points O1 and O2 from one (instantaneous) signal (determination of presence/absence of light reception illustrated in FIG. 2: step S11) obtained by the single-pixel light receiving element 22. That is, there is an effect that the processing unit 14 can identify whether a minute defect exists in either of the two object points O1 and O2 or whether a minute defect exists in neither of the two object points O1 and O2, depending on whether a signal is input into the single-pixel light receiving element 22.

Similarly, a configuration sensitive to the directional distribution of light (BRDF) as described above at each of the object points O1 and O2 on an object plane OS that can be received by the single-pixel light receiving element 22 enables minute defect inspection on the entire object plane OS from one (instantaneous) signal obtained by the single-pixel light receiving element 22.

Although the minute defect of the object O has been exemplified as a target from which information is acquired using the optical inspection apparatus 10 according to the present embodiment, any targets that scatter light instead of the minute defect may be used. As the target, for example, an abnormal surface roughness of the object O may be defined as a defect. Alternatively, any targets may be used as long as they scatter light, such as pores, foreign substances, and surface irregularities. Alternatively, a fluorescent region that absorbs light once and emits light may be the defect. That is, any regions where a change in widening of the directional distribution of light (BRDF) is different from that in the other regions may be used. According to the present embodiment, these can be detected based on the change in widening of the directional distribution of light (BRDF).

Thus, the optical inspection method according to the present embodiment includes calculating information on an object O including at least two different object points O1 and O2, based on a light reception signal received by a single-pixel light receiving element 22 through a light beam selection portion 26 that is provided between an image formation optical element 24 and the single-pixel light receiving element 22 and that is configured to selectively shield (light of) at least one wavelength included in lights from the object points O1 and O2, the image formation optical element being disposed at a position where the single-pixel light receiving element 22 configured to receive image points I1 and I2 corresponding to the object points O1 and O2 of the object. Alternatively, the optical inspection method according to the present embodiment includes acquiring information on a directional distribution of lights (BRDF) from at least two different object points O1 and O2 of an object O, based on a light reception signal received by a single-pixel light receiving element 22 through a light beam selection portion 26 that is provided between an image formation optical element 24 and the single-pixel light receiving element 22 and that is configured to selectively shield (light of) at least one wavelength included in lights from the object points O1 and O2, the image formation optical element being disposed at a position where the single-pixel light receiving element 22 configured to receive image points I1 and I2 corresponding to the object points O1 and O2.

As such, the present embodiment can provide the optical inspection apparatus 10 using a single pixel, the optical inspection method, and the non-transitory storage medium storing an optical inspection program, which are configured to acquire information on the directional distribution of light (BRDF), or configured to calculate information on the object O.

The example in which one single-pixel light receiving element 22 is used in the optical inspection apparatus 10 of the present embodiment has been described. In the optical inspection apparatus 10, a plurality of single-pixel light receiving elements 22 may be spatially disposed side by side. In this case, a product in which a plurality of single-pixel light receiving elements 22 are spatially disposed side by side can be used as an image sensor (area sensor or line sensor). In that case, there is an effect that the processing unit 14 can acquire information on the directional distribution of light (BRDF) in each of regions of an object O including at least two object points O1 and O2, and/or can calculate information on the object O including the at least two different object points O1 and O2. The same applies to optical inspection apparatuses 10 according to second to sixth embodiments which will be described later.

### (Modification 1)

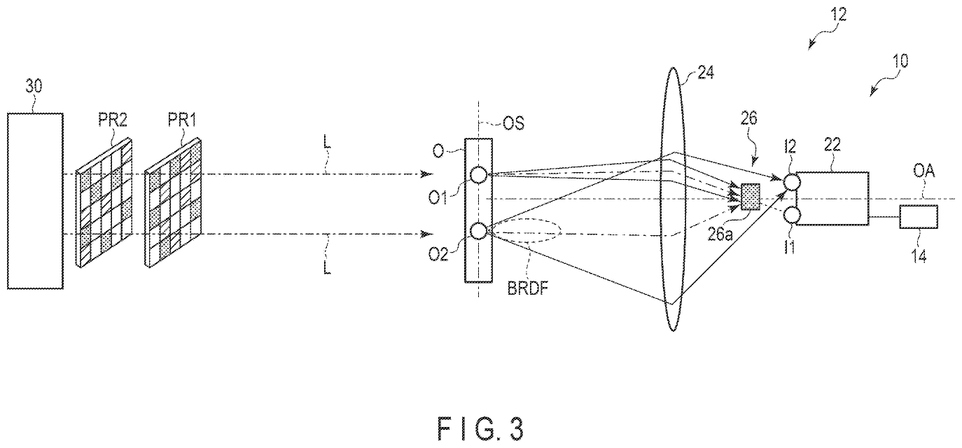

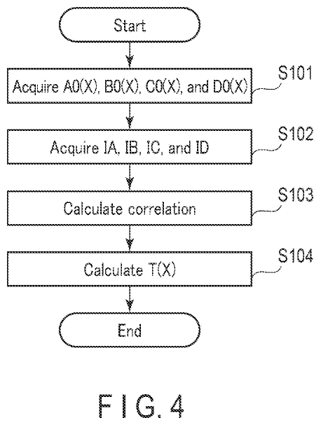

An optical inspection apparatus 10 according to Modification 1 will be described with reference to FIGS. 3 and 4. Here, the optical inspection apparatus 10 includes an illuminator 30.

In the Modification 1, for example, one or more processor of the processing unit 14 sequentially projects illumination light as pattern light from the illuminator 30 illustrated in FIG. 3 with the lapse of time. The pattern light has an illuminance distribution in the illumination. For example, the illuminator 30 can sequentially project various random pattern lights and Hadamard pattern lights (see G. M. Gibson, et. al., “Single-pixel imaging 12 years on: a review,” Optics Express, vol. 28, No. 19, 2020.). Note that the random pattern light has no correlation with the pattern projected one after another.

For example, the processor of the processing unit 14 synchronizes the illuminator 30 with a single-pixel light receiving element 22, and correlates the illumination light of the illuminator 30 with a light reception signal obtained by the single-pixel light receiving element 22 each time the illumination light is emitted. As a result, there is an effect that the processing unit 14 can obtain an image of an object plane OS using the single-pixel light receiving element 22. In addition, it is assumed that the single-pixel light receiving element 22 can spectrally disperse a first wavelength W1 and a second wavelength W2 from each other. That is, it is assumed that the single-pixel light receiving element 22 can receive an independent signal for each. That is, it is assumed that the single-pixel light receiving element 22 has spectroscopic performance. Here, for example, the first wavelength W1 and the second wavelength W2 are 450 nm and 650 nm, respectively.

The first wavelength W1 has a first pattern, and the second wavelength W2 has a second pattern. The processing unit 14 acquires, from the single-pixel light receiving element 22, an intensity distribution A0 (X) of light of the first wavelength W1 of a first pattern light PR1 and an intensity distribution B0 (X) of light of the second wavelength W2 of the first pattern light PR1 including the two patterns. The first wavelength W1 has a third pattern, and the second wavelength W2 has a fourth pattern. The processing unit 14 acquires, from the single-pixel light receiving element 22, an intensity distribution C0 (X) of light of the first wavelength W1 of a second pattern light PR2 and an intensity distribution D0 (X) of light of the second wavelength W2 of the second pattern light PR2 including the two patterns (S101). The processing unit 14 acquires, from the single-pixel light receiving element 22, signal intensity IA of the light of the first wavelength W1 having the first pattern included in the first pattern light PR1, signal intensity IB of the light of the second wavelength W2 having the second pattern included in the first pattern light PR1, signal intensity IC of the light of the first wavelength W1 having the third pattern included in the second pattern light PR2, and signal intensity ID of the light of the second wavelength W2 having the fourth pattern included in the second pattern light PR2 (S102). The processing unit 14 correlates the four signal intensities (IA, IB, IC, and ID) with the four intensity distributions (A0 (X), B0 (X), C0 (X), and D0 (X)) (S103). As a result, the processing unit 14 calculates information T (X) on the object O (S104). As described above, since the information T (X) about the object O is acquired, the optical inspection apparatus 10 can acquire image information T (X) about the object O. That is, the processing unit 14 acquires an image of the object O (information on the object O) based on a correlation between the pattern lights upon emission of the pattern lights from the illuminator 30 and the light reception signals in the single-pixel light receiving element 22 upon emission of the pattern lights from the illuminator 30.

For example, in a case where the signal intensities (IA and IB) of the first pattern light PR1 and the signal intensities (IC and ID) of the second pattern light PR2 are each acquired in step S102 in synchronization with the irradiation of the object plane O with each pattern light by the illuminator 30, the processing unit 14 can perform optical inspection on the object plane O according to the optical inspection processing illustrated in the flow of FIG. 2.

A resolution of the image is equivalent to that of the pattern light of the illuminator 30. This is also commonly referred to as ghost imaging method. In addition, the optical inspection apparatus 10 according to Modification 1 has an effect that a difference in directional distribution of light (BRDF) can be identified for each pixel (pixel of the image obtained by the ghost imaging method) using the processing unit 14. That is, in a pixel including only an image point corresponding to an object point having a narrow directional distribution of light (BRDF), light is shielded by the light beam selection portion 26, and thus the pixel does not appear in an image acquired by the processing unit 14 through the single-pixel light receiving element 22 (a pixel value does not have a substantially significant value). On the other hand, in a pixel including even one image point corresponding to an object point having a wide directional distribution of light (BRDF), light can pass through the light beam selection portion 26, and thus the pixel appears in an image acquired by the processing unit 14 through the single-pixel light receiving element 22 (a pixel value has a substantially significant value). Therefore, the optical inspection apparatus 10 according to the Modification 1 has an effect that the location of the minute defect can be specified.

The Modification 1 can provide the optical inspection apparatus 10 using a single pixel, the optical inspection method, and the non-transitory storage medium storing an optical inspection program, which are can obtain information on the directional distribution of light (BRDF), and/or can calculate information on the object O including the at least two different object points O1 and O2.

### (Modification 2)

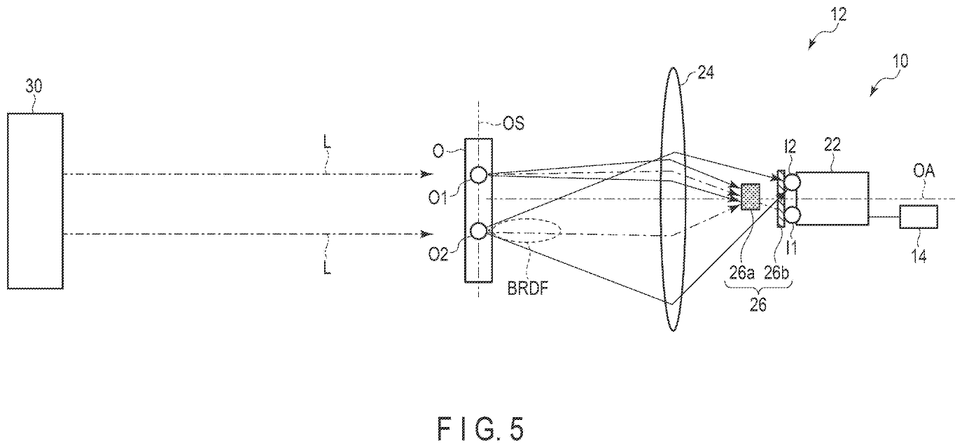

An optical inspection apparatus 10 according to Modification 2 will be described with reference to FIG. 5.

An illumination light includes light of another wavelength spectrum in addition to light of a first wavelength spectrum. That is, the illumination light includes lights of at least two different wavelength spectra. A light beam selection portion 26 includes a first selection region 26a and a second selection region 26b. The first selection region 26a in the Modification 2 is not limited to the shielding region, and a wavelength selection region that allows the light of the first wavelength spectrum to pass therethrough and shields light of the remaining wavelength spectrum is used. For the second selection region 26b, a filter with a complementary color to light of a wavelength in the wavelength selection region 26a is used. The wavelength selection region 26a allows light of a wavelength spectrum in which lights of some wavelengths are shielded to pass therethrough, unlike the wavelength spectra themselves of the illumination light. That is, the wavelength selection region 26a allows the light of the first wavelength spectrum to pass therethrough. The first wavelength spectrum is, for example, blue light having a peak at a wavelength of 450 nm.

In addition, it is assumed that the single-pixel light receiving element 22 of the Modification 2 does not have sensitivity to the light of the first wavelength spectrum. It is assumed that the single-pixel light receiving element 22 has sensitivity only to light of a wavelength spectrum with a complementary color to the first wavelength spectrum. For example, the single-pixel light receiving element 22 may include, as the second selection region 26b, a light receiving surface attached with a wavelength filter that transmits only a complementary color to the first wavelength spectrum.

As a result, at each of object points O1 and O2, only the light in which the illumination light is scattered and the directional distribution is widened is received by the single-pixel light receiving element 22. That is, for lights that are not scattered at the object point O1 and has a narrow directional distribution (blue light and light having another wavelength), blue light passes through the wavelength selection region 26a, but the light having another wavelength is shielded by the wavelength selection region 26a. The single-pixel light receiving element 22 does not have sensitivity to the blue light of the first wavelength spectrum. Thus, the blue light is not received by the single-pixel light receiving element 22. On the other hand, lights (blue light and light of another wavelength) having a widened directional distribution pass through a region except the wavelength selection portion 26a in the wavelength selection portion 26a, and light of a wavelength spectrum with a complementary color to the blue light passes through the complementary color filter 26b, and thus is received by the single-pixel light receiving element 22. As a result, there is an effect that the processing unit 14 can identify a difference in widening of the directional distribution of light (BRDF) at each of the object points O1 and O2 depending on whether light (complementary color to blue light) is received. Therefore, the optical inspection apparatus 10 can perform optical inspection on the object surface O according to the flow of the optical inspection processing illustrated in FIG. 2.

The Modification 2 can provide the optical inspection apparatus 10 using a single pixel, the optical inspection method, and the non-transitory storage medium storing an optical inspection program, which are configured to obtain information on the directional distribution of light (BRDF), or configured to calculate information on the object O.

### Second Embodiment

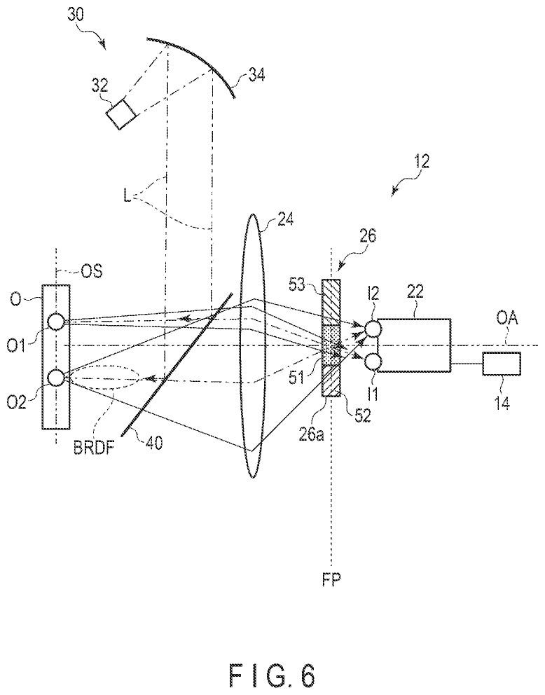

Hereinafter, an optical inspection apparatus 10 according to the present embodiment will be described with reference to FIG. 6. The basic structure of the optical inspection apparatus 10 according to the present embodiment is the same as that of the optical inspection apparatus 10 according to the first embodiment. Differences will be described below.

FIG. 6 shows a cross-sectional view illustrating the optical inspection apparatus 10 according to the present embodiment. The cross-sectional view of FIG. 6 includes an optical axis (imaging optical axis) OA of the imaging unit 12. In addition, the optical inspection apparatus 10 according to the present embodiment includes an illuminator 30 and a beam splitter 40. Furthermore, a light beam selection portion 26 according to the present embodiment is formed to have such a size that all lights incident on the single-pixel light receiving element 22 pass through the light beam selection portion 26. The light beam selection portion 26 is arranged on a focal plane (imaging-side focal plane) FP of the image formation optical element 24.

The single-pixel light receiving element 22 is a spectroscope having one light receiving surface. The spectroscope may be, for example, an optical spectrum analyzer using a scanning Michelson interferometer or a Czerny-Turner type spectroscope. However, the single-pixel light receiving element 22 in the present embodiment is not limited to this, and the single-pixel light receiving element 22 may be any element as long as the element includes one light receiving surface and can independently acquire light intensity signals for at least two different wavelengths.

The illuminator 30 includes a light source 32 and a reflector 34. An object plane OS is irradiated with the illumination light from the illuminator 30 via the beam splitter 40. The beam splitter 40 may be a non-polarization beam splitter, a half mirror, or a polarization beam splitter. In a case where the polarization beam splitter is used as the beam splitter 40, only light scattered from the object plane OS so that polarization is rotated (changed) is received by the single-pixel light receiving element 22. Therefore, the use of the polarization beam splitter as the beam splitter 40 provides an effect that only scattered light can be extracted in the single-pixel light receiving element 22.

In the first embodiment, the example in which light transmission at the object O is used has been described. In the present embodiment, an example in which reflection of light at the object O is used will be described. It is assumed that the object O to be inspected by the optical inspection apparatus 10 of the present embodiment is opaque, and that light is reflected on a surface of the object O. In the embodiment which will be described below, the same effect can be obtained even no matter whether the object O is transparent or opaque. When surface reflection is considered, it is assumed that the object O is a uniform medium in a case where there is no region where the light scattering characteristic locally changes on the surface of the object O. That is, it is assumed that a region in which the bidirectional reflectance distribution function (BRDF) is locally different on the surface of the object O is a defect (or minute defect), and that a region without such a region is a uniform medium.

The light source 32 of the illuminator 30 is, for example, a white LED. However, the light source 32 of the illuminator 30 is not limited to this, and may be any laser as long as it emits light.

The reflector 34 of the illuminator 30 is, for example, an off-axis parabolic mirror. The light source 32 is disposed at a focal point of the reflector 34. Thus, the light emitted from the light source 32 is converted into parallel light by the reflector 34. The reflector 34 utilizes specular reflection of light to change the direction of light in a geometric shape. Therefore, the conversion into parallel light by the reflector 34 does not depend on the wavelength of the light. That is, the reflector 34 has an effect that lights of all wavelengths of white light can be converted into parallel lights. On the other hand, when a lens is used instead of the reflector 34, a refraction angle of light slightly differs for each wavelength due to refractive index dispersion of the lens. Therefore, the use of the lens may cause chromatic aberration in the illumination light.

The light beam selection portion 26 includes, as the first selection region 26a, at least one wavelength selection region that allows light of a specific wavelength spectrum to pass therethrough from light including a plurality of different wavelength spectra incident on the light beam selection portion 26 and shields light of at least one remaining wavelength spectrum. The wavelength selection region 26a of the light beam selection portion 26 includes a first wavelength selection region 51, a second wavelength selection region 52, and a third wavelength selection region 53. The first wavelength selection region 51 allows light of a first wavelength spectrum to pass therethrough and shields light of at least one remaining wavelength spectrum. The second wavelength selection region 52 allows light of a second wavelength spectrum to pass therethrough and shields light of at least one remaining wavelength spectrum. That is, the lights having passed through the first wavelength selection region 51 and the second wavelength selection region 52 have different wavelength spectra. The wavelength spectrum of light having passed through the first wavelength selection region 51 is defined as the first wavelength spectrum, and the wavelength spectrum of light having passed through the second wavelength selection region 52 is defined as the second wavelength spectrum. In the present embodiment, the third wavelength selection region 53 allows passage of light of the same wavelength spectrum as the light of the second wavelength spectrum though having a shape different from that of the second wavelength selection region. That is, the third wavelength selection region 53 allows the light of the second wavelength spectrum to pass therethrough. However, the wavelength selection regions in the present embodiment are not limited to this, and any wavelength selection region may be employed as long as there is a region that allows lights of at least two different wavelength spectra to pass therethrough. It is assumed that the first wavelength selection region 51 intersects with the optical axis OA, and that the second wavelength selection region 52 and the third wavelength selection region 53 are at positions deviated from the optical axis OA. As an example, the first wavelength selection region 51 extends in a direction orthogonal to the paper surface of FIG. 6. Similarly, the second wavelength selection region 52 and the third wavelength selection region 53 extend in the direction orthogonal to the paper surface of FIG. 6.

The first wavelength spectrum is, for example, blue light having a peak at a wavelength of 450 nm. The second wavelength spectrum is, for example, red light having a peak at a wavelength of 650 nm. However, The first and second wavelength spectrums in the present embodiment are not limited to this, and any first wavelength spectrum and any second wavelength spectrum may be employed as long as they are different from each other.

The single-pixel light receiving element 22 is configured to identify (spectrally disperse) both the blue light (first wavelength spectrum) and the red light (second wavelength spectrum). That is, it is assumed that the single-pixel light receiving element 22 is configured to identify (spectrally disperse) light having a wavelength of 450 nm and light having a wavelength of 650 nm.

Based on the above configuration, an operation of the optical inspection apparatus 10 according to the present embodiment will be described.

For example, in a case where the object O is a uniform medium, all the lights emitted from the light source 32 of the illuminator 30 controlled by the processing unit 14 and converted into parallel lights by the reflector 34 reach an imaging-side focal point by the image formation optical element 24 of the imaging unit 12. On the other hand, the lights are scattered by the object O, and reach a position away from the focal point at the imaging-side focal plane FP.

For example, it is assumed that the first object point O1 is on a uniform medium, and that a minute defect exists at the second object point O2.

At this time, among the lights from the first object point O1, the blue light passes through the first wavelength selection region 51, reaches a first image point I1, and is received by the single-pixel light receiving element 22. The single-pixel light receiving element 22 controlled by the processing unit 14 detects the blue light. That is, the processing unit 14 acquires light intensity (pixel value) for a peak wavelength of the blue light as the light reception signal using the single-pixel light receiving element 22.

On the other hand, the light from the second object point O2 is scattered by the minute defect, and the directional distribution of light is widened. Then, the light having the widened directional distribution reaches the first wavelength selection region 51, the second wavelength selection region 52, and the third wavelength selection region 53. At this time, the light that has passed through the first wavelength selection region 51 becomes blue light, and the lights that have passed through the second wavelength selection region 52 and the third wavelength selection region 53 become red lights. Further, the lights reach a second image point 12 and are received by the single-pixel light receiving element 22. The single-pixel light receiving element 22 controlled by the processing unit 14 acquires light intensities (pixel values) for two different peak wavelengths of the blue light and the red light as light reception signals. That is, the single-pixel light receiving element 22 receives each of the light intensities for the two peak wavelengths. As a result, the processing unit 14 can recognize that a minute defect exists in the object surface illuminated with the parallel light.

It is assumed that each of the first object point O1 and the second object point O2 is a uniform medium and has no minute defect. At this time, the single-pixel light receiving element 22 acquires only the light intensity for the peak wavelength of the blue light, and cannot obtain the light intensity for the peak wavelength of the red light. That is, the single-pixel light receiving element 22 detects a signal different from the signal in a case where a minute defect exists at either one of the object points O1 and O2. As a result, if the light reception signal in the single-pixel light receiving element 22 is a signal of only the blue light, the processing unit 14 can find that there is no minute defect in the object plane OS illuminated with the parallel light L.

As described above, by using the optical inspection apparatus 10 according to the present embodiment, the information on the widening of the directional distribution of light can be obtained at the object plane OS illuminated with the parallel light L. Then, the optical inspection apparatus 10 according to the present embodiment has an effect of being able to identify the presence or absence of a minute defect based on the information.

In the present embodiment, upon irradiation of the object O with the illumination light L from the illuminator 30, blue light or both blue light and red light is/are received. Therefore, in step S1 in FIG. 2, a similar flow can be used if “Light received?” is changed to “Both blue light and red light received?”.

The present embodiment can provide the optical inspection apparatus 10 using a single pixel, the optical inspection method, and the non-transitory storage medium storing an optical inspection program, which are configured to acquire information on the directional distribution of light (BRDF), or configured to calculate information on the object O.

In the present embodiment, as described with reference to FIG. 3 (modifications of the first embodiment), the illumination light (parallel light) L of the illuminator 30 may be used as pattern light. For example, the processing unit 14 synchronizes the illuminator 30, and correlates the illumination light of the illuminator 30 with a light reception signal obtained by the single-pixel light receiving element 22 each time the illumination light is emitted. As a result, there is an effect that the processing unit 14 can obtain an image of an object plane OS using the single-pixel light receiving element 22.

A resolution of the image is equivalent to that of the pattern light of the illuminator 30. This is also commonly referred to as ghost imaging method. Furthermore, the optical inspection apparatus 10 according to the present embodiment has an effect that the information on the directional distribution of light (BRDF) can be identified for each pixel using the processing unit 14. That is, there is an effect that, in each pixel, the information on the directional distribution of light (BRDF) can be identified by color (spectral). As a result, the optical inspection apparatus 10 according to the present embodiment has an effect that the location of the minute defect can be specified by using pattern light.

### (Modification)

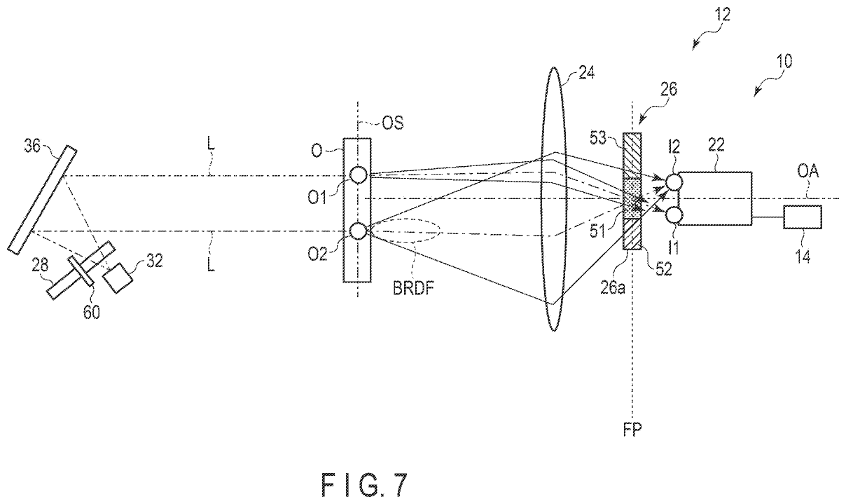

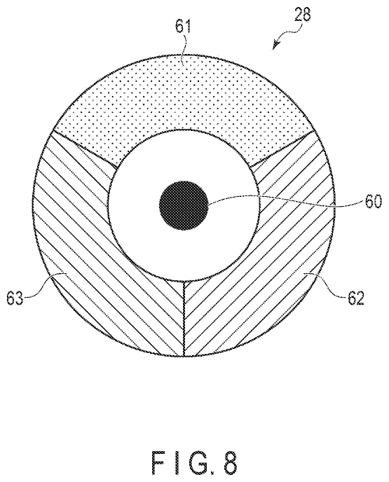

An optical inspection apparatus 10 according to a modification of the present embodiment will be described with reference to FIGS. 7 and 8. FIG. 7 shows a cross-sectional view illustrating the optical inspection apparatus 10 according to the present modification. The cross-sectional view of FIG. 7 includes an optical axis OA on an imaging side. In the present modification, a second light beam selection portion 28 is provided. On the other hand, a light beam selection portion on the imaging side is defined as first light beam selection portion 26 (the same as that illustrated in FIG. 6).

A single-pixel light receiving element 22 of an imaging unit 12 receives light and obtains a light reception signal. However, it is assumed that the single-pixel light receiving element 22 of the present modification cannot spectrally disperse light and cannot obtain an independent light reception signal for each wavelength of light. That is, the single-pixel light receiving element 22 of the present modification is disposed in the same manner as in FIG. 6, but is different from that illustrated therein. Alternatively, the processing unit 14 may control the single-pixel light receiving element 22 to receive only light of a specific wavelength spectrum. For example, in a case where the single-pixel light receiving element 22 is formed with three wavelengths of R, G, and B as light reception signals, the processing unit 14 may be capable of receiving, for example, only R signals, only G signals, or only B signals. Also, in a case where the single-pixel light receiving element 22 is formed with three wavelengths of R, G, and B as light reception signals, the processing unit 14 may use only R signals, only G signals, or only B signals as the light reception signals.

Similarly to the basic configuration of the second embodiment, the first light beam selection portion 26 on the imaging side includes a first selection region 51, a second selection region 52, and a third selection region 53. That is, these are the first wavelength selection region 51, the second wavelength selection region 52, and the third wavelength selection region 53, which are the same as those in the second embodiment. The first wavelength selection region 51 allows blue light to pass therethrough, and the second wavelength selection region 52 and the third wavelength selection region 53 allow red light to pass therethrough. It is assumed that the second selection region 52 and the third selection region 53 have different shapes but allow light having the same wavelength spectrum to pass therethrough.

The illuminator 30 is provided with a second light beam selection portion 28. The second light beam selection portion 28 is a color wheel, and rotates about a rotation axis 60. However, it is assumed that a rotation angle of a rotation axis 60 of the second light beam selection portion 28 can be electrically grasped by an encoder (not illustrated). It is assumed that the rotation angle of the second light beam selection portion 28 can be received by the processing unit 14.

FIG. 8 shows a front view of the color wheel that is the second light beam selection portion 28. The second light beam selection portion 28 includes a second-1 wavelength selection region 61, a second-2 wavelength selection region 62, and a second-3 wavelength selection region 63 around the rotation axis 60. The second-1 wavelength selection region 61 allows blue light to pass therethrough, the second-2 wavelength selection region 62 allows red light to pass therethrough, and the second-3 wavelength selection region 63 allows green light to pass therethrough. However, the green light has a peak wavelength of 550 nm.

The illuminator 30 includes a digital micromirror device (DMD) 36. The light emitted from a light source 32 passes through any one of the specific wavelength selection regions 61, 62, and 63 of the color wheel (second light beam selection portion 28), becomes light of a wavelength spectrum of any one of the wavelength selection regions 61, 62, and 63, and is reflected by the DMD 36. The DMD 36 can generate various pattern lights with the lapse of time. However, the wavelength spectrum of each pattern light is determined by the rotation angle of second light beam selection portion 28 (color wheel) at that time.

For example, a case where the illumination light passing through the second light beam selection portion 28 is red light will be considered. At this time, the red light widely scattered at an object point O2 passes through the second wavelength selection region 52 and the third wavelength selection region 53 of the first light beam selection portion 26 and is received by the single-pixel light receiving element 22. On the other hand, the red light having a narrow directional distribution, which is reflected without being scattered at the object point O1, reaches the first wavelength selection region 51 of the first light beam selection portion 26 and is shielded. Therefore, the light is not received by the single-pixel light receiving element 22. That is, there is an effect that, if a light reception signal corresponding to the red light is obtained by the single-pixel light receiving element 22, the processing unit 14 can detect the presence of an object point where light is scattered at at least one object point O2 so that the directional distribution of light is widened.

When the illumination light is blue light, the first wavelength selection region 51 allows blue light to pass therethrough. At this time, the light is always received by the single-pixel light receiving element 22 regardless of whether or not the light is scattered at the object points O1 and O2. The light reception signal of the blue light becomes the largest in a case where the object plane OS is on a uniform medium and there is no object that abnormally scatters light. On the other hand, the larger the region in which the light is scattered on the object plane OS, or the more widely the light scattered at a certain object point spreads, the smaller the light reception signal becomes. That is, there is an effect that the processing unit 14 can estimate the light scattering characteristic based on the change in intensity change (pixel value) of the light reception signal of the blue light.

Furthermore, in a case where the illumination light is green light, the light passing from the object plane OS through the image formation optical element 24 and directed toward the single-pixel light receiving element 22 is shielded by the light beam selection portion 26. As a result, if a green light signal can be obtained by the single-pixel light receiving element 22 at this time, it is noise. That is, there is an effect that noise can be estimated from the signal value in a case where the illumination is green light. There is an effect that, in a case where noise is obtained, the processing unit 14 can increase accuracy of detection by offsetting the noise from the light reception signal of the single-pixel light receiving element 22.

The Modification can provide the optical inspection apparatus 10 using a single pixel, the optical inspection method, and the non-transitory storage medium storing an optical inspection program, which are configured to acquire information on the directional distribution of light (BRDF), or configured to calculate information on the object O.

### Third Embodiment

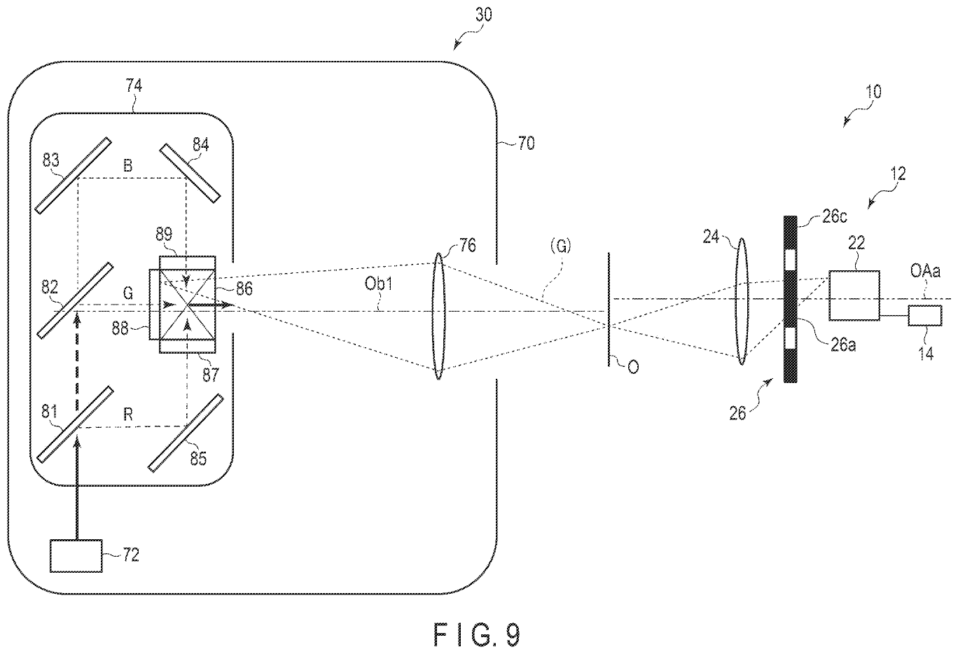

Hereinafter, an optical inspection apparatus 10 according to the present embodiment will be described in detail with reference to FIG. 9. The basic structure of the optical inspection apparatus 10 of the present embodiment is the same as that of the optical inspection apparatus 10 of the second embodiment. Differences will be described below.

In the optical inspection apparatus 10 of the present embodiment, the illuminator 30 includes a projector (PJ) 70. In the present embodiment, a single-pixel light receiving element 22 can receive visible light, but cannot spectrally disperse light. That is, the single-pixel light receiving element 22 acquires a monochrome signal. It is assumed that, in a light beam selection portion 26, a first selection region 26a is entirely formed of a shielding region. That is, the shielding region 26a is provided at the center of the light beam selection portion 26 (imaging optical axis OA and the vicinity thereof). Then, the light beam selection portion 26 allows a part of light outside the shielding region 26a to pass therethrough. Further, a shielding region 26c is provided on the outside away from the shielding region 26a.

The PJ 70 includes a light source 72, a multiplexing portion 74 and an illumination optical element 76.

The light source 72 is a white LED. However, the light source 72 is not limited to this, and may be any material as long as it emits light.

It is assumed that the illumination optical element 76 is a Fresnel lens. The Fresnel lens is an image formation optical element, and forms an image of light from an object point to an image point. However, the illumination optical element 76 is not limited to this, and may be any element as long as image formation of light can be performed in the present embodiment. An optical axis of the illumination optical element 76 is defined as illumination optical axis OAb, and is distinguished from an imaging optical axis OAa. Both the imaging optical axis OAa and the illumination optical axis OAb may coincide with each other, but may be different from each other.

The multiplexing portion 74 includes two dichroic mirrors 81 and 82, three mirrors 83, 84, and 85, one cross dichroic prism 86, and transmission type liquid crystal display (LCD) panels 87, 88, and 89.

The transmission type liquid crystal display (LCD) panels 87, 88, and 89 are respectively disposed on three surfaces of the cross dichroic prism 86. However, without limitation to this, the LCD may be a digital micromirror device (DMD) or a liquid crystal on silicon (LCOS). That is, any spatial modulator that modulates a space to create a projection image of light may be used instead of the LCD. The spatial modulator may operate mechanically, but desirably operates electrically.

Next, an operation of the optical inspection apparatus 10 according to the present embodiment will be described.

The light emitted from the light source 72 of the PJ 70 enters the multiplexing portion 74, blue light and green light are transmitted through the first dichroic mirror 81, and red light is reflected. The red light is reflected by the third mirror 85 and passes through the transmission type LCD panel 87. The blue light and the green light transmitted through the first dichroic mirror 81 reach the second dichroic mirror 82, the blue light is transmitted, and the green light is reflected. The green light reflected by the second dichroic mirror 82 passes through the transmission type LCD panel 88. The blue light having transmitted through the second dichroic mirror 82 is further reflected by the first mirror 83 and the second mirror 84, and passes through the transmission type LCD panel 89. At this time, pattern lights are generated according to the patterns of the LCD panels 87, 88, and 89. The green light and the red light similarly become pattern lights. Then, all of the blue light, the green light, and the red light are multiplexed by the cross dichroic prism 86, become multi-wavelength (white) pattern lights and emitted from the PJ 70. On an illumination side, multi-wavelength pattern lights are projected from object points on the LCD panels 87, 88, and 89 toward image points by the illumination optical element 76. The image point corresponds to the object point of the object on the imaging side.

When the object O is a uniform medium, light is slightly scattered at the object O and becomes light with a narrow directional distribution. On the other hand, in a case where a minute defect such as a foreign substance exists in the object O, light is widely scattered. Such scattering is referred to as specific scattering.

In a case where light is not specifically scattered at an object point, the shielding region 26a of the light beam selection portion 26 is disposed to shield the light. On the other hand, the shielding region 26a is also formed so as to allow light to pass therethrough in a case where the light is singularly scattered by the object point so that the directional distribution is widened. That is, the light is specifically scattered by the minute defect so that the directional distribution of the light is widened, whereby the light can pass between the shielding regions 26a and 26c. As described above, if there is no minute defect in the object O, the light from each object point is not received by the single-pixel light receiving element 22. On the other hand, in a case where a minute defect exists at an object point, the light is received by the single-pixel light receiving element 22. As a result, there is an effect that the processing unit 14 can identify the presence or absence of a minute defect in the object plane OS.

In the present embodiment, the pattern light is Hadamard pattern light (see G. M. Gibson, et. al., “Single-pixel imaging 12 years on: a review,” Optics Express, vol. 28, No. 19, 2020.). The illuminator 30 can sequentially project pattern lights with the lapse of time. For example, the processing unit 14 correlates the illumination light with a light reception signal obtained by the single-pixel light receiving element 22 each time the illumination light is emitted. As a result, the processing unit 14 can obtain an image (information on the surface of the object O) using the single-pixel light receiving element 22. A resolution of the image is equivalent to that of the pattern light of the illuminator 30. This is also commonly referred to as ghost imaging method. The optical inspection apparatus 10 according to the present embodiment has an effect that the light scattering characteristic can be estimated on the object surface using the processing unit 14. That is, since an object point having a narrow directional distribution of light is shielded by the light beam selection portion 26, the object point does not appear in the image acquired by the processing unit 14 through the single-pixel light receiving element 22. On the other hand, since an object point having a wide directional distribution of light can pass through the light beam selection portion, the object point appears in the image acquired by the processing unit 14 through the single-pixel light receiving element 22. Therefore, the optical inspection apparatus 10 according to the present embodiment has an effect that the location of the minute defect can be specified.

The image obtained by the processing unit 14 of the present embodiment is a dark field image, and the pixel value of the minute defect can be made larger than that of the uniform medium, and thus there is an effect that the S/N is improved.

The present embodiment can provide the optical inspection apparatus 10 using a single pixel, the optical inspection method, and the non-transitory storage medium storing an optical inspection program, which are configured to acquire information on the directional distribution of light (BRDF), or configured to calculate information on the object O.

### Fourth Embodiment

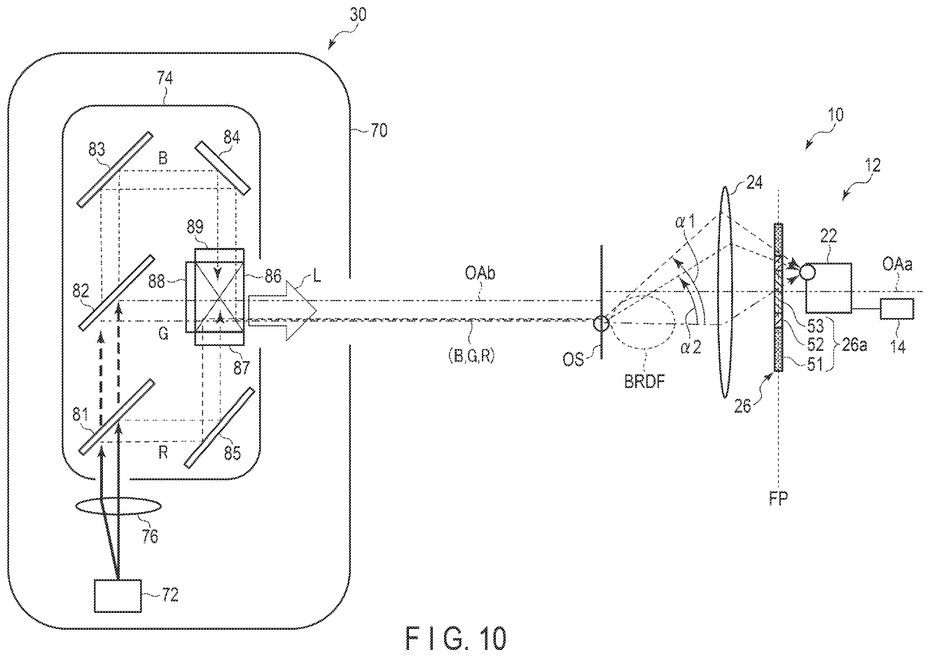

Hereinafter, an optical inspection apparatus 10 according to the present embodiment will be described with reference to FIG. 10. The basic structure of the optical inspection apparatus 10 of the present embodiment is the same as that of the optical inspection apparatus 10 of the third embodiment. Differences will be described below.

FIG. 10 shows a schematic cross-sectional view illustrating an optical inspection apparatus 10 according to the present embodiment. The cross-sectional view of FIG. 10 simultaneously includes an illumination optical axis OAb and an imaging optical axis OAa.

The illumination light is light formed of a plurality of wavelength spectra including first, second, and third wavelength spectra. The light beam selection portion 26 includes a first wavelength selection region 51 that transmits light of a first wavelength spectrum and shields light of at least one remaining wavelength spectrum, a second wavelength selection region 52 that transmits light of a second wavelength spectrum and shields light of at least one remaining wavelength spectrum, and a third wavelength selection region 53 that transmits light of a third wavelength spectrum and shields light of at least one remaining wavelength spectrum. However, it is assumed that the first wavelength selection region 51, the second wavelength selection region 52, and the third wavelength selection region 53 of the light beam selection portion 26 are concentric (coaxial) with the imaging optical axis OAa. That is, it is assumed that, in the light beam selection portion 26, the first wavelength selection region 51, the second wavelength selection region 52, and the third wavelength selection region 53 are disposed in this order from a position away from the imaging optical axis OAa toward the imaging optical axis (center) OAa. Note that the light of the first wavelength spectrum is blue light, that the light of the second wavelength spectrum is red light, and that the light of the third wavelength spectrum is green light. That is, the center of the light beam selection portion 26 allows green light to pass therethrough, the outside thereof allows red light to pass therethrough, and the outside thereof allows blue light to pass therethrough.

The single-pixel light receiving element 22 is a spectroscope, and can acquire a peak wavelength of the blue light, a peak wavelength of the green light, and a peak wavelength of the red light as different independent signals.

In the present embodiment, an illumination optical element 76 is disposed between a light source 72 and a multiplexing portion 74 of a PJ 70. It is assumed that the illumination optical element 76 is a Fresnel lens. The Fresnel lens can produce parallel light by disposing the light source 72 at a focal point. The parallel light may be any substantially parallel light, and may have a slight divergence angle. However, the illumination optical element 76 is not limited to this, and any element may be used as long as it can convert the light from the light source 72 into parallel light. The illumination optical element 76 that converts the light from the light source 72 into parallel light may be, for example, a compound parabolic concentrator (CPC). The CPC is known to be a non-image-forming optical system. That is, the CPC does not have a function of forming an image of an object point to an image point. The illumination optical element 76 may be a non-image-forming optical element.

Next, an operation of the optical inspection apparatus 10 according to the present embodiment will be described.

The light emitted from the light source 72 reaches the illumination optical element (Fresnel lens) 76 and is converted into parallel light. The parallel light is incident on the multiplexing portion 74 of the PJ 70, the blue light and the green light are transmitted through the first dichroic mirror 81, and the red light is reflected. The red light is reflected by the third mirror 85 and passes through the transmission type LCD panel 87. The blue light and the green light transmitted through the first dichroic mirror 81 further reach the second dichroic mirror 82, the blue light is transmitted, and the green light is reflected. The green light reflected by the second dichroic mirror 82 passes through the transmission type LCD panel 88. The blue light having transmitted through the second dichroic mirror 82 is further reflected by the first mirror 83 and the second mirror 84, and passes through the transmission type LCD panel 89. At this time, pattern lights are generated according to the patterns of the LCD panels. The green light and the red light similarly become pattern lights. Then, all of the blue light, the green light, and the red light are multiplexed by the cross dichroic prism 86, become multi-wavelength (white) pattern lights and emitted from the PJ 70. Here, multi-wavelength pattern lights are parallel lights along the illumination optical axis OAb.

Depending on the size of a pixel (resolution) of spatial modulation of the LCD panel, diffracted light having a direction different from that of the illumination optical axis OAb may be generated. That is, pattern light having a direction inclined with respect to the illumination optical axis OAb can be generated. However, by sufficiently separating the PJ 70 and the object O from each other, the diffracted light generated by a spatial modulator can be formed not to be received by the single-pixel light receiving element 22.

Since the light beam selection portion 26 is disposed on a focal plane (imaging-side focal plane) FP of the image formation optical element 24, the position for passage through the light beam selection portion 26 is determined according to the light beam direction with respect to the imaging optical axis OAa at each of object points O1 and O2. That is, the light beam parallel to the imaging optical axis OAa at the object point O passes through the focal point (imaging-side focal point). Therefore, the light beam reaches the third wavelength selection region 53. At this time, an angle formed by the light beam and the imaging optical axis OAa is defined as a third angle α3≈0°. Furthermore, at the object point O, a light beam slightly inclined with respect to the imaging optical axis OAa reaches the second wavelength selection region 52 slightly away from the focal point on the focal plane (imaging-side focal plane) FP. At this time, an angle formed by the light beam and the imaging optical axis OAa is defined as a second angle α2. In addition, a light beam greatly inclined with respect to the imaging optical axis OAa reaches the first wavelength selection region 51 greatly away from the focal point on the focal plane (imaging-side focal plane) FP. At this time, an angle formed by the light beam and the imaging optical axis OAa is defined as a first angle α1. As described above, the wavelength spectrum of the light passing through the light beam selection portion 26 varies according to the angle between the light beam and the imaging optical axis OAa. That is, in a case where the angle formed with the imaging optical axis OAa is 0°=the third angle α3 (not illustrated), the wavelength spectrum of the light passing through the light beam selection portion 26 is that of green light. In a case where the angle formed with the imaging optical axis OAa becomes the second angle α2, the wavelength spectrum of the light passing through the light beam selection portion 26 becomes that of red light, and in a case where the angle formed with the imaging optical axis OAa becomes the first angle α1, the wavelength spectrum of the light passing through the light beam selection portion 26 becomes that of blue light.

Since the single-pixel light receiving element 22 is a spectroscope, signal intensities (pixel values) can be acquired independently for the peak wavelengths of the blue light, the red light, and the green light. Therefore, the processing unit 14 can estimate the direction of light from these signals. Furthermore, the processing unit 14 can also estimate the widening of the directional distribution of light (BRDF).

In the present embodiment, the pattern light is random pattern light (see G. M. Gibson, et. al., “Single-pixel imaging 12 years on: a review,” Optics Express, vol. 28, No. 19, 2020.). The pattern light can be projected one after another with the lapse of time. For example, the processing unit 14 correlates the illumination light of the illuminator 30 with a light reception signal obtained by the single-pixel light receiving element 22 each time the illumination light is emitted. As a result, the processing unit 14 can obtain an image (information on the surface of the object O) using the single-pixel light receiving element 22. A resolution of the image is equivalent to that of the pattern light of the illuminator 30. This is also commonly referred to as ghost imaging method.

As described above, there is an effect that the processing unit 14 can identify the directional distribution of light for each object point by the signal for each wavelength received by the single-pixel light receiving element 22. That is, there is an effect that the processing unit 14 can identify the direction of light, the directional distribution of light, or the widening of the directional distribution of light from the intensity of the signal received independently for each peak wavelength of the blue light, the red light, or the green light. That is, the processing unit 14 can acquire information on scattering of light, or information on transmission (reflection) direction, information on transmission (reflection) directional distribution, and information on widening of transmission (reflection) directional distribution. In addition, there is an effect that this enables the processing unit 14 to inspect the shape and nature of the object surface, the presence or absence of a foreign substance, and the like.

The present embodiment can provide the optical inspection apparatus 10 using a single pixel, the optical inspection method, and the non-transitory storage medium storing an optical inspection program, which are configured to acquire information on the directional distribution of light (BRDF), or configured to calculate information on the object O.

### Fifth Embodiment

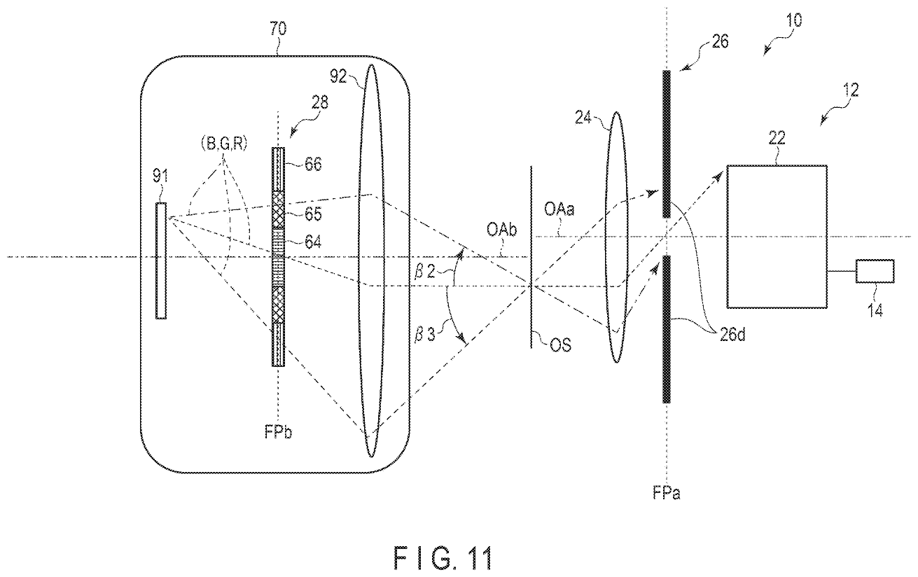

Hereinafter, an optical inspection apparatus according to the present embodiment will be described with reference to FIG. 11. The basic structure of the optical inspection apparatus 10 according to the present embodiment is the same as that of the optical inspection apparatus 10 of the fourth embodiment. Differences will be described below.

FIG. 11 shows a cross-sectional view illustrating the optical inspection apparatus 10 according to the present embodiment. The cross-sectional view of FIG. 11 includes an imaging optical axis OAa and an illumination optical axis OAb.

A PJ 70 is provided as an illuminator 30. The PJ 70 according to the present embodiment includes a spatial modulator 91 and an illumination optical element 92. The spatial modulator 91 may be an LCD, an LCOS, a DMD, or the like. That is, the spatial modulator 91 may be any spatial modulator as long as it creates a projection image of light by electrical modulation. Here, the spatial modulator 91 is an LCD.

The illumination optical element 92 is an image formation optical element, for example, an achromatic lens. The use of the achromatic lens can reduce chromatic aberration of illumination light L. An optical axis of the achromatic lens is defined as illumination optical axis OAb.

The first light beam selection portion (imaging-side light beam selection portion) 26 is provided, for example, on an imaging side between an image formation optical element 24 and the single-pixel light receiving element 22. In addition, the second light beam selection portion (illumination-side light beam selection portion) 28 is provided on an illumination side between the spatial modulator 91 and the illumination optical element 92 of the PJ 70. The imaging-side light beam selection portion 26 includes a concentric shielding region around the imaging optical axis OAa.

The illumination-side light beam selection portion 28 includes a concentric wavelength selection region around the illumination optical axis OAb. It is assumed that a wavelength spectrum of light from a light source (not illustrated) includes at least lights of first, second, and third wavelength spectra. These are referred to as a second-1 wavelength selection region 64, a second-2 wavelength selection region 65, and a second-3 wavelength selection region 66. The second-1 wavelength selection region 64 allows blue light to pass therethrough as the light of the first wavelength spectrum and shields wavelengths of the remaining second and third wavelength spectra different from that of the blue light. The second-2 wavelength selection region 65 allows green light to pass therethrough as the light of the second wavelength spectrum and shields lights of the remaining first and third wavelength spectra different from that of the green light. The second-3 wavelength selection region 66 allows red light to pass therethrough as the light of the third wavelength spectrum and shields lights of the remaining first and second wavelength spectra different from that of the red light.

The imaging-side light beam selection portion 26 is disposed on a focal plane FPa of the image formation optical element 24 on the imaging side. The imaging-side light beam selection portion 26 is opened at a position along the imaging optical axis OAa, and has a shielding region 26d on the outer side thereof.

The illumination-side light beam selection portion 28 is disposed on a focal plane FPb of the illumination optical element 92 on the illumination side. Since the illumination-side light beam selection portion 28 is disposed on the focal plane FPb of the illumination optical element 92 on the illumination side, the position for passage through the illumination-side light beam selection portion 28 and the angle of the passing light beam formed with the illumination optical axis OAb can be associated with each other. That is, the blue light passing through the illumination-side focal point FPb becomes parallel to the illumination optical axis OAb and reaches the object plane O on the imaging side. At this time, assuming that the angle of the blue light formed with the illumination optical axis OAb is a first angle β1 (not illustrated), the angle β1 is 0° (sufficiently, β1≈0°. In addition, at the illumination-side focal plane FPb, the green light passing through a position slightly away from the focal point has a second angle β2 formed with the illumination optical axis OAb. Similarly, at the illumination-side focal plane FPb, the red light passing through a position greatly away from the focal point has a third angle β3 formed with the illumination optical axis OAb. Here, the third angle β3 is larger than the second angle β2.

The single-pixel light receiving element 22 is a spectroscope, and can acquire signal intensities independently for the peak wavelengths of the blue light, the green light, and the red light.

An operation of the optical inspection apparatus 10 of the present embodiment will be described below.

In the present embodiment, the pattern light is Hadamard pattern light (see G. M. Gibson, et. al., “Single-pixel imaging 12 years on: a review,” Optics Express, vol. 28, No. 19, 2020.). For example, the processing unit 14 controls the spatial light modulator 91 of the PJ 70 to sequentially project the pattern light with the lapse of time, and correlates the pattern light with the light reception signal obtained by the single-pixel light receiving element each time. However, the processing unit 14 performs image correlation on each of the blue light, the green light, and the red light. As a result, there is an effect that the processing unit 14 can obtain an image using the single-pixel light receiving element 22. A resolution of the image is equivalent to that of the pattern light. This is also commonly referred to as ghost imaging method.

When the object is a uniform medium, no light scattering occurs at the object. On the other hand, if a minute defect such as a foreign substance exists in the object, light is scattered.

In a case where the object is a uniform medium, the first light beam selection portion 26 on the imaging side shields the green light and the red light passing through each object point with the shielding region 26d, and allows only the blue light to pass through the center axis (optical axis OAa) of the shielding region 26d and an opening provided in the vicinity thereof. On the other hand, in a case where the light is scattered by the minute defect so that the directional distribution of light is widened, a part of each of the green light and the red light also passes through the opening of the shielding region 26d. As described above, if there is no minute defect in the object O, only the blue light among the lights from the respective object points is received by the single-pixel light receiving element 22. On the other hand, the single-pixel light receiving element 22 receives the green light or the red light, that is, lights of two or three wavelength spectra, in addition to blue light, at the object point where the minute defect exists. As a result, there is an effect that the processing unit 14 can identify the presence or absence of a minute defect at each object point on the object plane OS. In addition, there is an effect that the processing unit 14 can estimate that the widening of the directional distribution of light at the object point is wider in a case where the green light and the red light are simultaneously detected than that in a case where only the green light is detected. That is, the processing unit 14 can obtain information on the magnitude of light scattering at each object point. As a result, the processing unit 14 can perform optical inspection on the shape and nature of the object surface, the presence or absence of a foreign substance, and the like.

The present embodiment can provide the optical inspection apparatus 10 using a single pixel, the optical inspection method, and the non-transitory storage medium storing an optical inspection program, which are configured to acquire information on the directional distribution of light (BRDF), or configured to calculate information on the object O.

### Sixth Embodiment

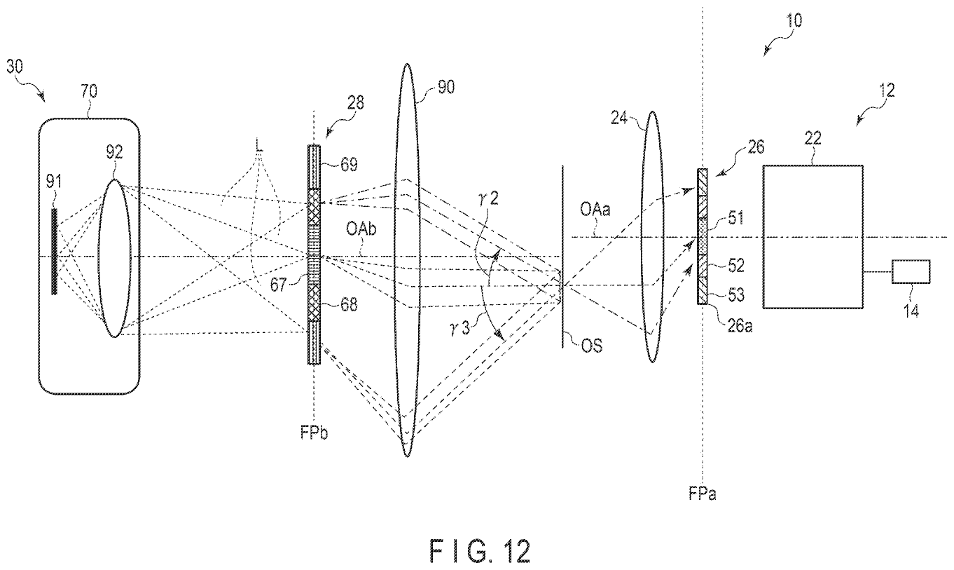

Hereinafter, an optical inspection apparatus 10 according to the present embodiment will be described in detail with reference to FIG. 12. The basic structure of the optical inspection apparatus 10 of the present embodiment is the same as that of the optical inspection apparatus 10 of the fifth embodiment. Differences will be described below.

FIG. 12 shows a cross-sectional view illustrating the optical inspection apparatus 10 according to the present embodiment. The cross-sectional view of FIG. 12 includes an imaging optical axis OAa and an illumination optical axis OAb.

The optical inspection apparatus 10 includes an illumination optical element 90 on an illumination side. The first illumination optical element 90 is an image formation optical element. For example, the first illumination optical element 90 is a Fresnel lens. The first illumination optical element 90 has a first illumination-side focal plane FPb. The illumination optical axis OAb is an optical axis of the first illumination optical element 90.

The optical inspection apparatus 10 includes a PJ 70 on the illumination side. The PJ 70 includes a spatial modulator 91 and a second illumination optical element 92. The spatial modulator 91 may be an LCD, an LCOS, a DMD, or the like. That is, the spatial modulator 91 may be any spatial modulator as long as it creates a projection image of light by electrical modulation. Here, the spatial modulator 91 is an LCD. An optical axis of the second illumination optical element 92 may be different from the optical axis (illumination optical axis) OAb of the first illumination optical element 90. The second illumination optical element 92 is an image formation optical element, for example, an achromatic lens. The use of the achromatic lens can reduce chromatic aberration of illumination light.

A light beam selection portion 26 is disposed on a focal plane FPa of an image formation optical element 24 on an imaging side. This is referred to as first light beam selection portion. Alternatively, it is referred to as imaging-side light beam selection portion. The imaging-side light beam selection portion 26 includes a concentric wavelength selection region around the imaging optical axis OAa. In the present embodiment, the imaging-side light beam selection portion 26 includes a first-1 wavelength selection region 51, a first-2 wavelength selection region 52, and a first-3 wavelength selection region 53.

The light beam selection portion 28 on the illumination side generates light by projecting an image on the focal plane FPb of the first illumination optical element 90 using the PJ 70. The image projected by the PJ 70 in this manner is defined as the illumination-side light beam selection portion (second light beam selection portion) 28. However, the illumination-side light beam selection portion 28 does not actually have an entity, and is just an image projected by the PJ 70. The illumination-side light beam selection portion 28 includes a concentric wavelength selection region around the illumination optical axis OAb. The illumination-side light beam selection portion 28 includes a second-1 wavelength selection region 67, a second-2 wavelength selection region 68, and a second-3 wavelength selection region 69. The second-1 wavelength selection region 67 is for blue light, the second-2 wavelength selection region 68 is for green light, and the second-3 wavelength selection region 69 is for red light. In this manner, the use of the image projected by the PJ 70 as the second light beam selection portion 28 provides an effect that the light beam selection portion can be freely changed, or enlarged or reduced in size. For this reason, concentric illumination of the blue light, the green light, and the red light is formed at each object point of an object O through the first illumination optical element 90 from the central axis toward the outside along the optical axis OAb.

Because of no entity, nothing may be disposed on the first illumination-side focal plane FPb, but a light diffuser may be disposed on the first illumination-side focal plane FPb. The light diffuser has a function of diffusing light. The light diffuser may be, for example, frosted glass. However, the light diffuser is not limited to this, and may be a transmission type or a reflection type. The light diffuser may be a phosphor that converts a wavelength to generate divergent light. By disposing the light diffuser on the first illumination-side focal plane FPb, lights in various directions can be incident on each object point. In a case where the light diffuser is not disposed, the number of light beams occupying an incident solid angle may greatly vary for each object point, or the number of light beams occupying the incident solid angle may be small depending on the object point. Therefore, there is an effect that the light diffuser is disposed, thereby increasing the number of light beams occupying the incident solid angle at each object point and suppressing a variation for each object point.

The first-1 wavelength selection region 51, the first-2 wavelength selection region 52, and the first-3 wavelength selection region 53 of the first light beam selection portion (imaging-side light beam selection portion) 26 shield the blue light, the green light, and the red light, respectively, and allow passage of complementary colors of the blue light, the green light, and the red light, respectively. That is, the first-1 wavelength selection region 51 shields the blue light, but allows the green light and the red light to pass therethrough. The first-2 wavelength selection region 52 shields the green light, but allows the blue light and the red light to pass therethrough. The first-3 wavelength selection region 53 shields the red light, but allows the blue light and the green light to pass therethrough.

On the illumination side, the second light beam selection portion 28 is formed by projection onto the focal plane (first illumination-side focal plane) FPb of the first illumination optical element 90, and thus the position of the light passing through the light beam selection portion 28 and the angle of the light passing through the light beam selection portion 28 and then directed toward the object point formed with the illumination optical axis OAb can be associated with each other. That is, the blue light passing through the illumination-side focal point becomes parallel to the illumination optical axis OAb. Assuming that the angle of the blue light formed with the illumination optical axis OAb is a first angle γ1 (not illustrated), the angle is 0° (sufficiently, γ1≈0°. In addition, at the illumination-side focal plane FPb, the green light passing through a position slightly away from the focal point has a second angle γ2 formed with the illumination optical axis OAb. Similarly, at the illumination-side focal plane FPb, the red light passing through a position greatly away from the focal point has a third angle γ3 formed with the illumination optical axis OAb. Here, the third angle γ3 is larger than the second angle γ2.

It is assumed that the single-pixel light receiving element 22 receives a monochrome signal and cannot spectrally disperse light.

An operation of the present embodiment will be described below.

In the present embodiment, the pattern light is Hadamard pattern light (see G. M. Gibson, et. al., “Single-pixel imaging 12 years on: a review,” Optics Express, vol. 28, No. 19, 2020.). The processing unit 14 controls the illuminator 30 to sequentially project the pattern light with the lapse of time, and correlates the pattern light with the light reception signal obtained by the single-pixel light receiving element 22 each time. As a result, there is an effect that an image can be obtained using the single-pixel light receiving element 22. A resolution of the image is equivalent to that of the pattern light. This is also commonly referred to as ghost imaging method.

When the object is a uniform medium, no light scattering occurs at the object. On the other hand, ifs a minute defect such as a foreign substance exists in the object, light is scattered.

When the object is a uniform medium, the first light beam selection portion 26 on the imaging side shields blue light, green light, and red light, and shields all illumination lights in order to allow complementary colors of the blue light, the green light, and the red light to pass therethrough. On the other hand, in a case where light is scattered by a minute defect so that the directional distribution of light is widened, any or all of a complementary color of blue light, a complementary color of green light, or a complementary color of red light is/are allowed to pass. As described above, if there is no minute defect in the object O, the illumination light is not received by the single-pixel light receiving element 22. On the other hand, at an object point where a minute defect exists in the object O, the illumination light is received by the single-pixel light receiving element 22. As a result, there is an effect that the processing unit 14 can identify the presence or absence of a minute defect at each object point on the object plane OS. That is, the processing unit 14 can obtain information on the magnitude of light scattering at each object point. As a result, the optical inspection apparatus 10 can perform optical inspection on the shape and nature of the object surface, the presence or absence of a foreign substance, and the like.

In the present embodiment, the image projected by the PJ 70 is used as the second light beam selection portion 28. As a result, the second light beam selection portion 28 can be electrically freely changed. Therefore, there is an effect that the correspondence relationship between the solid angle of illumination incident on the object surface and the color of light (blue light, green light, or red light) can be changed. That is, there is an effect that the sensitivity to the widening of the directional distribution of light can be adjusted and optimized.

The present embodiment can provide the optical inspection apparatus 10 using a single pixel, the optical inspection method, and the non-transitory storage medium storing an optical inspection program, which are configured to acquire information on the directional distribution of light (BRDF), or configured to calculate information on the object O.

The optical inspection apparatus 10, the optical inspection method, and the non-transitory storage medium storing an optical inspection program, according to at least one embodiment as described above, are configured to acquire information on the directional distribution of light (BRDF) using a single pixel, or configured to calculate information on the object O using a single pixel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical inspection apparatus comprising:
a single-pixel light receiving element;
an image formation optical element disposed at a position where the single-pixel light receiving element configured to receive image points corresponding to at least two different object points of an object; and
a first light beam selection portion that is provided between the image formation optical element and the single-pixel light receiving element and that is configured to selectively shield at least one wavelength included in lights from the object points.

2. The optical inspection apparatus according to claim 1, wherein the first light beam selection portion includes at least one shielding region that is configured to shield light.

3. The optical inspection apparatus according to claim 1, wherein the first light beam selection portion includes at least one wavelength selection region that allows light of at least one wavelength spectrum to pass therethrough from a plurality of different wavelength spectra of light incident on the first light beam selection portion and that is configured to shield light of at least one remaining wavelength spectrum.

4. The optical inspection apparatus according to claim 3, wherein
the first light beam selection portion includes:
a first wavelength selection region that allows light of a first wavelength spectrum included in the different wavelength spectra to pass therethrough and that is configured to shield light of at least one wavelength spectrum different from the light of the first wavelength spectrum; and
a second wavelength selection region that allows light of a second wavelength spectrum different from the light of the first wavelength spectrum, which is included in the different wavelength spectra, to pass therethrough, and that is configured to shield light of at least one wavelength spectrum different from the light of the second wavelength spectrum.

5. The optical inspection apparatus according to claim 1, wherein the first light beam selection portion includes at least one polarized light selection region formed by a polarizing plate.

6. The optical inspection apparatus according to claim 1, wherein the first light beam selection portion is disposed at or near a focal plane of the image formation optical element.

7. The optical inspection apparatus according to claim 1, wherein the single-pixel light receiving element is configured to acquire lights of one or more different wavelength spectra as light reception signals.

8. The optical inspection apparatus according to claim 1, further comprising one or more processor configured to:
acquire a light reception signal acquired by the single-pixel light receiving element; and
calculate information on a directional distribution of lights from the object points based on the light reception signal.

9. The optical inspection apparatus according to claim 1, further comprising one or more processor configured to:
acquire a light reception signal acquired by the single-pixel light receiving element; and
calculate information on the object including the object points based on the light reception signal.

10. The optical inspection apparatus according to claim 1, further comprising:
an illuminator that is configured to emit different pattern lights toward the object as time passes; and
one or more processor that is configured to acquire an image of the object based on a correlation between the pattern lights upon emission of the pattern lights from the illuminator and light reception signals in the single-pixel light receiving element upon emission of the pattern lights from the illuminator.

11. The optical inspection apparatus according to claim 10, wherein
the illuminator includes an illumination optical element, and
a wavelength selection portion is disposed at or near a focal plane of the illumination optical element, the wavelength selection portion including:
a first wavelength selection region that allows light of a first wavelength spectrum from the illuminator to pass therethrough and that is configured to shield light of at least one remaining wavelength spectrum different from the light of the first wavelength spectrum; and
a second wavelength selection region that allows light of a second wavelength spectrum different from the light of the first wavelength spectrum, from the illuminator, to pass therethrough, and that is configured to shield light of at least one remaining wavelength spectrum different from the light of the second wavelength spectrum.

12. The optical inspection apparatus according to claim 10, wherein
the illuminator includes:
an illumination optical element; and
a second light beam selection portion provided at a focal plane of the illumination optical element, and
the illuminator is configured to form the second light beam selection portion as a projection image of light by electrical modulation.

13. The optical inspection apparatus according to claim 10, wherein
the illuminator is an electrically operated projector.

14. An optical inspection method, comprising at least one of acquiring information on a directional distribution of lights from at least two different object points of an object, or calculating information on an object including at least two different object points,
based on a light reception signal received by a single-pixel light receiving element through a first light beam selection portion that is provided between an image formation optical element and the single-pixel light receiving element and that is configured to selectively shield light of at least one wavelength included in lights from the object points,
the image formation optical element being disposed at a position where the single-pixel light receiving element configured to receive image points corresponding to the object points.

15. The optical inspection method according to claim 14, further comprising:
emitting different pattern light toward the object as time passes; and
acquiring an image of the object based on a correlation between the pattern light upon emission of the pattern light toward the object and the light reception signal in the single-pixel light receiving element upon emission of the pattern light toward the object.

16. A non-transitory storage medium storing an optical inspection program, the optical inspection program causing a computer to execute:
at least one of acquiring information on a directional distribution of lights from at least two different object points of an object, or calculating information on an object including at least two different object points,
based on a light reception signal received by a single-pixel light receiving element through a first light beam selection portion that is provided between an image formation optical element and the single-pixel light receiving element and that is configured to selectively shield light of at least one wavelength included in lights from the object points,
the image formation optical element being disposed at a position where the single-pixel light receiving element configured to receive image points corresponding to the object points.
